(19) United States
(12) Patent Application Publication
(10) Pub. No.: US 2011/0085288 A1
(43) Pub. Date: Apr. 14, 2011

(54) All-In-One Desktop Computer

(75) Inventors: Wei-Chih Lai, Taipei (TW); Yao-Jen Chang, Taipei (TW); Wei-Ting Lai, Taipei (TW); Chia-Fen Tsou, Taipei (TW); Hsin-Hung Hsiao, Taipei (TW)

(73) Assignee: PEGATRON CORPORATION, Taipei (TW)

(21) Appl. No.: 12/898,899

(22) Filed: Oct. 6, 2010

(30) Foreign Application Priority Data
Oct. 12, 2009 (TW) 098134522

(51) Int. Cl. G06F 1/16

(52) U.S. Cl. 361/679.21

(57) ABSTRACT

An all-in-one desktop computer includes a casing, a display module, a motherboard, a storage device, and a heat dissipating device. The display module is contained in the casing. The display module has a display panel exposed to the casing. The storage device is located at a center-of-gravity position of the all-in-one desktop computer. The motherboard, the storage device, and the heat dissipating device are contained in the casing and are disposed at the back of the display module without overlap. Therefore, the all-in-one desktop computer has smaller volume and a better heat dissipation effect via special disposition of the motherboard, the storage device, and the heat dissipating device.

### CROSS REFERENCE TO RELATED APPLICATIONS

This Non-provisional application claims priority under 35 U.S.C. §119(a) on Patent Application No(s). 098134522 filed in Taiwan, Republic of China Oct. 12, 2009, the entire contents of which are hereby incorporated by reference.

### BACKGROUND OF THE INVENTION

1. Field of Invention

This invention relates to a desktop compute and, more particularly, to an all-in-one desktop computer.

2. Related Art

A user may use a computer to process documents, to draw pictures, to communicate with others, share knowledge and experience by Internet, such that the computer has gradually become a necessary electronic product for an individual and a company.

FIG. 1 is a schematic diagram showing a conventional desktop computer. A desktop computer 1 includes a display 11 and a main body 12. The main body 12 may include components such as a motherboard, a central processing unit (CPU), a hard disk drive, a heat dissipating device (not shown), and an optical disk drive 121 and so on, and the components are disposed in a casing 122. The main body 12 is connected with the display 11 by connection wires.

However, the display 11 and the main body 12 of the desktop computer 1 are different components and independent from each other. Therefore, the desktop computer 1 has disadvantages such as large volume and lot of space occupation and so on, thereby causing difficulty of the computer arrangement and operation for users.

### SUMMARY OF THE INVENTION

One objective of this invention is to provide an all-in-one desktop computer capable of allowing a display module, a motherboard, a storage device, and a heat dissipating device to be contained in a casing thus to reduce volume of the desktop computer.

Another objective of the invention is to provide an all-in-one desktop computer including a motherboard, a storage device, and a heat dissipating device to be disposed. By arrangements of the motherboard, the storage device, and the heat dissipating device, the all-in-one desktop computer in the invention can still use the same size of the motherboard, storage device, and heat dissipating device to correspond to display modules with different or similar sizes. Otherwise, for the display module with the same size, different sizes of the motherboard, the storage device, and the heat dissipating device can still be selected.

According to the above, in the invention, an all-in-one desktop computer includes a casing, a display module, a motherboard, a storage device, and a heat dissipating device. The display module is contained in the casing, and the display module has a display panel exposed to the casing. The storage device is located at a center-of-gravity position of the all-in-one desktop computer. The motherboard, the storage device, and the heat dissipating device are contained in the casing and are disposed at the back of the display module without overlap.

In one embodiment of the invention, the motherboard, the heat dissipating device, and the heat dissipating device may be located at one plane or different planes.

In one embodiment of the invention, the casing may have a plurality of heat dissipating openings corresponding to the heat dissipating device.

In one embodiment of the invention, the casing may have a plurality of air inlets adjacent to the bottom of the casing.

In one embodiment of the invention, the storage device may include a hard disk drive disposed at the center-of-gravity position of the all-in-one desktop computer to improve stability of the whole structure.

According to above, this invention discloses an all-in-one desktop computer for allowing the display module, the motherboard, the storage device, and the heat dissipating device to be contained in one casing, thereby being capable of reducing volume of the desktop computer. In addition, the motherboard, the storage device, and the heat dissipating device in the invention do not overlap each other. In addition, according to the desktop computer in the invention, the storage device can further be disposed adjacent to the center-of-gravity position to increase stability of the whole structure.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a conventional desktop computer;

FIG. 2 is a schematic diagram showing an all-in-one desktop computer according to one preferred embodiment of this invention;

FIG. 3 is a schematic diagram showing a motherboard, a heat dissipating device, and a storage device disposed at different areas according to one preferred embodiment of the invention;

FIG. 4 is a schematic diagram showing a motherboard, a heat dissipating device, and a storage device disposed at different areas in another form according to one preferred embodiment of the invention; and

FIG. 5 is a back view of an all-in-one desktop computer according to one preferred embodiment of the invention.

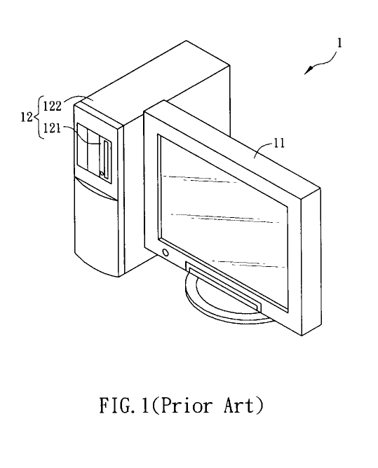

### DETAILED DESCRIPTION OF THE INVENTION

One preferred embodiment of an all-in-one desktop computer is described hereinbelow, and the same element is marked by the same reference number.

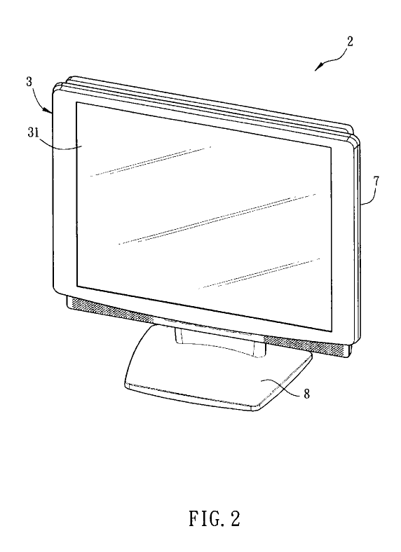

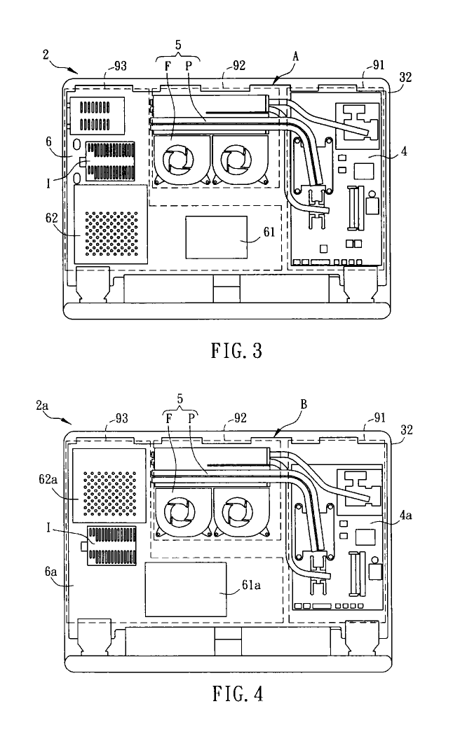

Please refer to FIG. 2 and FIG. 3 together. FIG. 2 is a schematic diagram showing an all-in-one desktop computer according to one embodiment of the invention. FIG. 3 is a schematic diagram showing a motherboard, a heat dissipating device, and a storage device of an all-in-one desktop computer disposed at different areas according to one embodiment of the invention. A casing and a base are not shown in FIG. 3. The all-in-one desktop computer needs to include a casing, and it may also include a base or a supporting element according to practical requirements.

An all-in-one desktop computer 2 includes a display module 3, a motherboard 4, a heat dissipating device 5, a storage device 6, and a casing 7. The display module 3, the motherboard 4, the heat dissipating device 5, and the storage device 6 are contained in the casing 7. The motherboard 4, the heat dissipating device 5, and the storage device 6 are included in main body module A. The display module 3 and the main body module A are opposite to each other. In detail, the motherboard 4, the heat dissipating device 5, and the storage device 6 are disposed at the back of the display module 3, and they do not overlap each other. In addition, in the embodiment, the all-in-one desktop computer 2 further includes a base 8, and the base 8 is connected with the casing 7 for supporting the all-in-one desktop computer 2 and allowing the all-in-one desktop computer 2 to be capable of being disposed at a plane, such as a tabletop.

The display module 3 has a display panel 31. In the embodiment, the display module further has a back panel 32, and the display panel 31 is exposed to the casing 7 and disposed at one side of the back panel 32. In the embodiment, the display module 3 may be a liquid crystal display (LCD) module, a light-emitting diode (LED) display module, an organic light-emitting display (OLED) module, a field emission display (FED) module, or a plasma display panel (PDP) module.

The main body module A is disposed at the other side of the back panel 32. That is, the main body module A is disposed at an opposite side of the side of the back panel 32 that the display panel 31 is disposed. In the embodiment, the opposite side of the back panel 32 where the main body module A is disposed may be divided into a motherboard area 91, a heat dissipating area 92, and a storage area 93. In the embodiment, the motherboard 4, the heat dissipating device 5, and the storage device 6 are disposed at the motherboard area 91, the heat dissipating area 92, and the storage area 93, respectively.

In FIG. 3, the motherboard area 91 is substantially rectangular and is located at one side area of the back panel 32. In the embodiment, the motherboard area 91 is located at a right side area of the back panel 32. In other words, the motherboard 4 is located at the right side area of the back panel 32. The storage area 93 is substantially L-shaped and is located at another side area of the back panel 32. In the embodiment, the storage area 93 is located at a left side area of the back panel 32. In other words, the storage device 6 is located at the left side area of the back panel 32. That is, the motherboard 4 and the storage device 6 are disposed at two side areas of the back panel 32, respectively.

The heat dissipating area 92 is substantially rectangular, and it is located at an upper portion of the back panel 32 and is located between the motherboard area 91 and the storage area 93. In other words, the heat dissipating device 5 is located at the upper portion of the back panel 32. Via the special division disposition, sharing ability of the back panel 32 is improved, and the display module 3, the motherboard 4, the heat dissipating device 5, or the storage device 6 with different sizes can be assembled according to practical needs. As the sharing ability of the back panel 32 is improved, there is no need to additionally mold different casings to satisfy customized needs.

The motherboard 4 is disposed at the motherboard area 91. In the embodiment, the motherboard 4 is located at one side area of the back panel 32. The motherboard 4 can include a central processing unit (CPU), a chipset, a universal serial bus (USB) connecting port, a card reading port, an audio input output port, an input interface connecting port, a network connecting port, or a combination thereof. An input device connected with the input interface connecting port may include a digital board, a joystick, a keyboard, or a mouse.

The heat dissipating device 5 is disposed at the heat dissipating area 92. In the embodiment, the heat dissipating device 5 is located at the upper portion of the back panel 32. The heat dissipating device 5 includes a heat dissipating fan, a heat dissipating film, a heat sink, a heat pipe, or a combination thereof. The heat dissipating fan may be an axial-flow fan or a centrifugal fan. In the embodiment, the heat dissipating device 5 including a plurality of heat dissipating fans F and a plurality of heat pipes P is taken for example, and the heat pipes P are connected with electronic elements of the motherboard 4 for dissipating heat generated by the electronic elements when the motherboard 4 runs.

The storage device 6 is disposed at the storage area 93. In the embodiment, the storage device 6 is located at another side area of the back panel 32. In addition, the storage device 6 is disposed at a center-of-gravity position of the all-in-one desktop computer 2. The storage device 6 includes a hard disk drive 61. Certainly, according to practical needs, the storage device 6 can further include an optical disk drive 62, and the optical disk drive 62 is adjacent to the hard disk drive 61. In addition, according to different using specification, the hard disk drive 61 may have different sizes such as 1.8″, 2.5″, or 3.5″ and so on. In this embodiment, the hard disk drive 61 may have a size of 2.5″. However, the invention is not limited thereto. The optical disk drive 62 may be a CD-ROM optical disk drive (CD-ROM ODD), a CD-R optical disk drive, a CD-RW optical disk drive, a DVD-ROM optical disk drive, a DVD-R optical disk drive, or a blue-ray disk (BD) drive.

In addition, the hard disk drive 61 may be disposed at the center-of-gravity position of the all-in-one desktop computer 2 to improve the stability of the whole structure of the all-in-one desktop computer 2. In the embodiment, the center-of-gravity position of the all-in-one desktop computer 2 may be located at the bottom middle. Therefore, the hard disk drive 61 is disposed at the bottom middle of the back panel 32 thus to prevent the all-in-one desktop computer 2 from shaking when the hard disk drive 61 runs. Since an inverter I of the display module 3 is disposed at a top left of the back panel 32, i.e., the top left of the storage area 93, when the disposition places of the hard disk drive 61 and the optical disk drive 62 are changed, the positions of the optical disk drive 62 and the inverter I may be changed, thereby preventing the hard disk drive 61 or the optical disk drive 62 from overlapping the inverter Ito affect a heat dissipating effect.

In the embodiment, the motherboard 4, the heat dissipating device 5, and the storage device 6 may be substantially located at the same plane or different planes. The different planes mean that the motherboard 4, the heat dissipating device 5, and the storage device 6 may be located at different heights. However, the disposition principle is that the motherboard 4, the heat dissipating device 5, and the storage device 6 do not overlap each other, thereby being capable of preventing the motherboard 4, the heat dissipating device 5, and the storage device 6 from being stacked on each other to affect the heat dissipating efficiency.

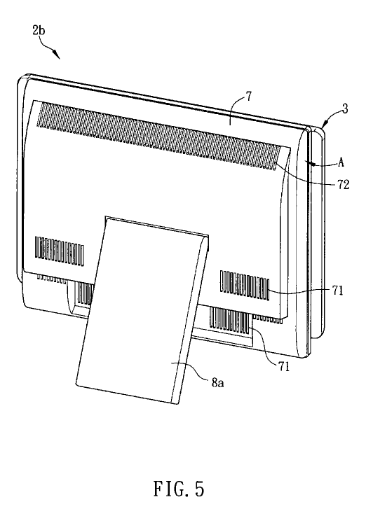

In addition, FIG. 4 is a schematic diagram showing an all-in-one desktop computer according to another embodiment of the invention. A size of a hard disk drive 61a of a storage device 6a in an all-in-one desktop computer 2a may be 3.5″. Therefore, an optical disk drive 62a is be disposed at a top left of a storage area 93, and an inverter I of a display module (not shown) is disposed between the hard disk drive 61a and the optical disk drive 62a. Certainly, to save space, the inverter I may also overlap the optical disk drive 62a. In addition, in this embodiment, a size of a motherboard 4a is smaller than that of the motherboard 4 in the above embodiment. Please refer to FIG. 3 and FIG. 4 together. Corresponding to different functions or design needs, the area of the motherboards 4, 4a at the motherboard area 91 can be increased or reduced in the condition that the relative poisons of the motherboards 4, 4a, the heat dissipating device 5, and the storage devices 6, 6a are not affected, while the same back panel 32 may still be used, thus improving sharing ability of the back panel 32.

In FIG. 2 and FIG. 3, by disposing the motherboard 4, the heat dissipating device 5, and the storage device 6 at a certain area, respectively, the same motherboard 4, the same heat dissipating device 5, and the same storage device 6 can be used to correspond to the display module 3 with different sizes or similar sizes, or the motherboard 4, the heat dissipating device 5, and the storage device 6 with different sizes or functions can be disposed to correspond to the display module 3 with the same size, thereby avoiding additionally molding different casings 7 to correspond to the display module 3, the motherboard 4, the heat dissipating device 5, or the storage device 6 with different sizes for the customized all-in-one desktop computer 2.

In addition, corresponding to different functions or design needs, in the condition that the relative position of the motherboard 4, the heat dissipating device 5, and the storage device 6 is not affected, the area of the motherboard 4 may be increased or reduced, while the same back panel 32 is still used. Thereby, selectivity of the motherboard 4, the heat dissipating device 5, and the storage device 6 can be improved, and the corresponding back panel 32 can be prevented from being additionally manufactured or the corresponding casing 7 can be prevented from being additionally molded to correspond to different functions or design needs for the all-in-one desktop computer 2.

In addition, the display module 3 of the all-in-one desktop computer 2 in the embodiment can be a conventional display module instead of manufacturing another display module 3 for cooperating with the all-in-one desktop computer 2 in the embodiment, thereby effectively reducing the manufacturing cost of the all-in-one desktop computer 2 in the embodiment. In addition, the all-in-one desktop computer 2 in the embodiment can also update the motherboard 4, the heat dissipating device 5, or the storage device 6 by itself according to needs or designs needed by users. For example, the CPU may be updated, the memory number or capacity of the motherboard may be increased, or the hard disk drive 61 may be changed, thus to satisfy needs of users.

FIG. 5 is a back view of an all-in-one desktop computer according to another embodiment of the invention. In the embodiment, an all-in-one desktop computer 2b further includes a supporting element 8a connected with a casing 7 for supporting the all-in-one desktop computer 2b and allowing the all-in-one desktop computer 2b to be capable of being disposed at one plane. A display module 3, a motherboard, a heat dissipating device, and a storage device are contained in the casing 7. A display panel of the display module 3 is exposed to the casing 7, and the casing 7 totally covers the motherboard, the heat dissipating device, and the storage device. The structures and arrangements of the motherboard, the heat dissipating device, and the storage device can be use the form in FIG. 3 or FIG. 4. However, the invention is not limited thereto.

The casing 7 has a plurality of air inlets 71 and a plurality of heat dissipating openings 72. The heat dissipating openings 72 correspond to the heat dissipating device to allow the heat drawn by the heat dissipating device to be dissipated outside via the heat dissipating openings 72. The positions of air inlets 71 correspond to that of the heat dissipating openings 72. The air inlets 71 are disposed adjacent to the bottom of the all-in-one desktop computer 2b, and the heat dissipating openings 72 are disposed adjacent to the top of the all-in-one desktop computer 2b. The air inlets 71 and the heat dissipating openings 72 form a heat dissipating path (heat convection). Air enters into the casing 7 from outside via the air inlets 71 adjacent to the bottom of the all-in-one desktop computer 2b, and the heat dissipating device such as a heat dissipating fan draws the air in to blow the heat generated by a main body module upward. Finally, the heat is dissipated via the heat dissipating openings 72 thus to achieve the heat dissipating effect.

To sum up, this invention discloses an all-in-one desktop computer with display module, the motherboard, the storage device, and the heat dissipating device contained in the same casing. The display panel and the motherboard, the storage device, and the heat dissipating device are disposed at two sides of the back panel, respectively, thereby being capable of reducing volume of the desktop computer. In addition, the opposite side of the back panel of the display module where the main body module is disposed is divided into a motherboard area, a heat dissipating area, and a storage area. The motherboard area and the storage area are located at two side areas of the back panel, and the heat dissipating area is located at the upper portion of the back panel and is located between the motherboard area and the storage area. Therefore, by dividing one side of the back panel where the main body module is disposed, the motherboard, the heat dissipating device, and the storage device of the main body module can be disposed at a certain area, respectively. Thereby, the same motherboard, the same storage device, and the same heat dissipating device can correspond to the display module with different sizes or similar sizes, or the motherboard, the storage device, and the heat dissipating device with different sizes or functions can be disposed to correspond to the display module with the same size, thereby being capable of avoiding additionally molding different casings to correspond to the display module, the motherboard, the storage device, or the heat dissipating device with different sizes for the customized all-in-one desktop computers.

In addition, corresponding to different functions or design needs, in the condition that the relative position of the motherboard, the heat dissipating device, and the storage device is not affected, the area of the motherboard can be increased or reduced, while the same back panel can still be used, thereby improving sharing ability of the back panel. Therefore, selectivity of the motherboard, the heat dissipating device, and the storage device can be improved, and the corresponding back panel can be prevented from being additionally manufactured, or different casings can be prevented from being additionally molded according to different functions or design needs for the customized all-in-one desktop computers. In addition, according to the desktop computer in the invention, the hard disk drive can further be disposed at the center-of-gravity position of the desktop computer, thus to increase the stability of the whole structure.

Furthermore, in the invention, the display module of the all-in-one desktop computer can be a conventional display module instead of a display module additionally manufactured for cooperating with the all-in-one desktop computer in the invention, thereby effectively reducing manufacturing cost of the all-in-one desktop computer in the invention. In addition, the all-in-one desktop computer in the invention can update the motherboard, the heat dissipating device, and the storage device by itself according to functions or design needs of users. For example, the central processing unit may be updated, the memory number or capacity of the motherboard may be increased, or the hard disk drive may be changed, thus to satisfy needs of users.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An all-in-one desktop computer comprising:
a casing;
a display module contained in the casing, the display module having a display panel exposed to the casing;
a motherboard;
a storage device located at a center-of-gravity position of the all-in-one desktop computer; and
a heat dissipating device, wherein the motherboard, the storage device, and the heat dissipating device are contained in the casing and are disposed at the back of the display module without overlap.

2. The all-in-one desktop computer according to claim 1, wherein the motherboard, the storage device, and the heat dissipating device are located at one plane.

3. The all-in-one desktop computer according to claim 1, wherein the motherboard, the storage device, and the heat dissipating device are located at different planes.

4. The all-in-one desktop computer according to claim 1, wherein the display module further has a back panel opposite to the display panel.

5. The all-in-one desktop computer according to claim 4, wherein the heat dissipating device is disposed at an upper portion of the back panel.

6. The all-in-one desktop computer according to claim 1, wherein the casing has a plurality of heat dissipating openings corresponding to the heat dissipating device.

7. The all-in-one desktop computer according to claim 1, wherein the casing has a plurality of air inlets adjacent to the bottom of the casing.

8. The all-in-one desktop computer according to claim 1, wherein the motherboard comprises a central processing unit (CPU), a chipset, a universal serial bus (USB) connecting port, a card reading port, an audio input output port, an input interface connecting port, a network connecting port, or a combination thereof.

9. The all-in-one desktop computer according to claim 1, wherein the heat dissipating device comprises a heat dissipating fan, a heat dissipating film, a heat sink, a heat dissipating fin, a heat pipe, or a combination thereof.

10. The all-in-one desktop computer according to claim 1, wherein the storage device comprises a hard disk drive and an optical disk drive, and the optical disk drive is adjacent to the hard disk drive.

11. The all-in-one desktop computer according to claim 1, wherein the storage device comprises a hard disk drive disposed at the center-of-gravity position of the all-in-one desktop computer.
